(19) United States
(12) Patent Application Publication
(10) Pub. No.: US 2023/0016682 A1
(43) Pub. Date: Jan. 19, 2023

(54) METHOD OF GROUPING CONNECTIONS BETWEEN MEMBERS IN A CONSTRUCTION MODELLING PROGRAM

(71) Applicant: International Design Services, Inc., St. Louis, MO (US)

(72) Inventors: Jesus Lazaro Dela Cruz IBARRETA, Loma De Gato (PH); Mylene De Leon JOSON, Lagro Novaliches (PH); Corby Ramos TOLENTINO, San Juan Taytay Rizal (PH)

(21) Appl. No.: 17/683,286

(22) Filed: Feb. 28, 2022

Related U.S. Application Data
(63) Continuation of application No. 15/947,265, filed on Apr. 6, 2018, now abandoned.
(60) Provisional application No. 62/483,318, filed on Apr. 7, 2017.

(51) Int. Cl. G06F 30/13

(52) U.S. Cl. CPC G06F 30/13; G06F 2111/20

(57) ABSTRACT

A computer implemented method of automatically identifying the components that belong to the same connection between members in a model existing in a building information modelling program. The method includes accepting a user selection of a portion of the model for processing; processing the selected portion of the model to identify connection components; and sorting the identified connection components into connection groups using a set of rules.

### CROSS-REFERENCED APPLICATION

This application claims priority to U.S. nonprovisional application Ser. No. 15/947,265, which claims priority to U.S. provisional application Ser. No. 62/483,318 filed on Apr. 7, 2017. The disclosure of the above-referenced application is incorporated herein by reference in its entirety.

### FIELD

This disclosure relates to construction modelling programs, and in particular to methods of automating the identification of connections between the elements in the modelling program without human intervention.

### BACKGROUND

This section provides background information related to the present disclosure which is not necessarily prior art.

Tekla is a family of software products from Trimble, Inc. of Sunnyvale, Calif., for design, detailing, and analysis in the building and construction industries. The software enables users to create and manage 3D structural models in steel and concrete. A model such as a Tekla model typically comprises a plurality of columns and beams (members). These members are connected by various components. Each component within the program has a number of properties, such as ID, name, and number. There are at least two types of components that can form part of a connection: a connection object, which connects two or more members, and a detail object which connects to only one member.

A difficulty for some users of the Tekla software, and similar software from other sources, is the fast and accurate identification of all of the constituents of a connection in the structure that is modeled in the software. Typically this must be done manually by a user and is subject to human error.

### SUMMARY

This section provides a general summary of the disclosure, and is not a comprehensive disclosure of its full scope or all of its features.

Embodiments of the present invention provide a system and method for automatically identifying the constituents of a connection in a structural model. The following description will illustrate these systems and methods in the contact of Tekla software, but it should be understood that they apply to other modeling software as well.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart of the Set Connection Group process employed in the preferred embodiment of this method;

FIG. 2 is a flow chart of the Get Component Details process employed in the preferred embodiment of this method, and referenced in the FIG. 1 flow chart;

FIG. 3 is a flow chart of the Group Connection Component process employed in the preferred embodiment of this method, and referenced in the FIG. 1 flow chart;

FIG. 4 is a flow chart of the Group Detail Component process employed in the preferred embodiment of this method, and referenced in the FIG. 1 flow chart;

FIG. 5 is a flow chart of the Assign Connection Group process employed in the preferred embodiment of this method, and referenced in the FIG. 4 flow chart; and

FIG. 6 is a flow chart of the Group Component Details process employed in the preferred embodiment of this method, and referenced in the FIG. 5 flow chart.

Corresponding reference numerals indicate corresponding parts throughout the several views of the drawings.

### DETAILED DESCRIPTION

Example embodiments will now be described more fully with reference to the accompanying drawings.

A preferred embodiment of this invention provides a system for and method of automatically identifying the constituents of connections between the members in a modelling program, such as Tekla, without human intervention. However the invention is not so limited, and the principles disclosed could be applied to other modeling programs.

In a Tekla model there are usually a plurality of members and beams that are joined with connections. The connection is formed by one or more components attached to a primary member and a secondary member. There are several types of components, including connection objects, which connect two or more members, and detail objects which connect to only one member. Some components are parent components, i.e., a component that has one or more sub-components or child components. To properly characterize a connection, then one must identify the connection objects, detail objects, as well as the child components of the connection objects.

For convenience, a Tekla model is usually divided into sections or “phases”. The method of the preferred embodiment begins with the user selection of the volume in the model surrounding the connection or connections of interest. This volume may include all or part of a single phase, or it may span multiple phases, or even all of the phases.

Main Set Connection Process

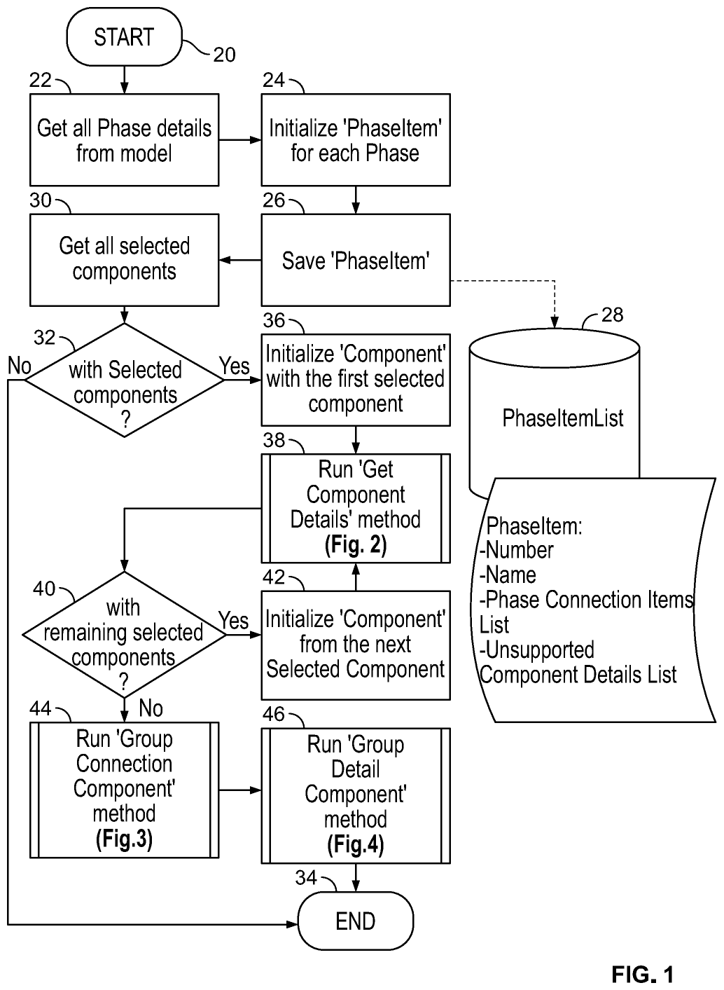

As shown in FIG. 1 at 22, all of the phase details for the identified phases are obtained from the Tekla model. These phase details include the Phases's name and number. At 24 a PhaseItem variable is initialized for each phase corresponding to the initial user selection. The PhaseItem for each phase, comprising the Phase Number, the Phase Name, a Phase Connection Items List, and an Unsupported Component Details List, are saved in a PhaseItem List 28.

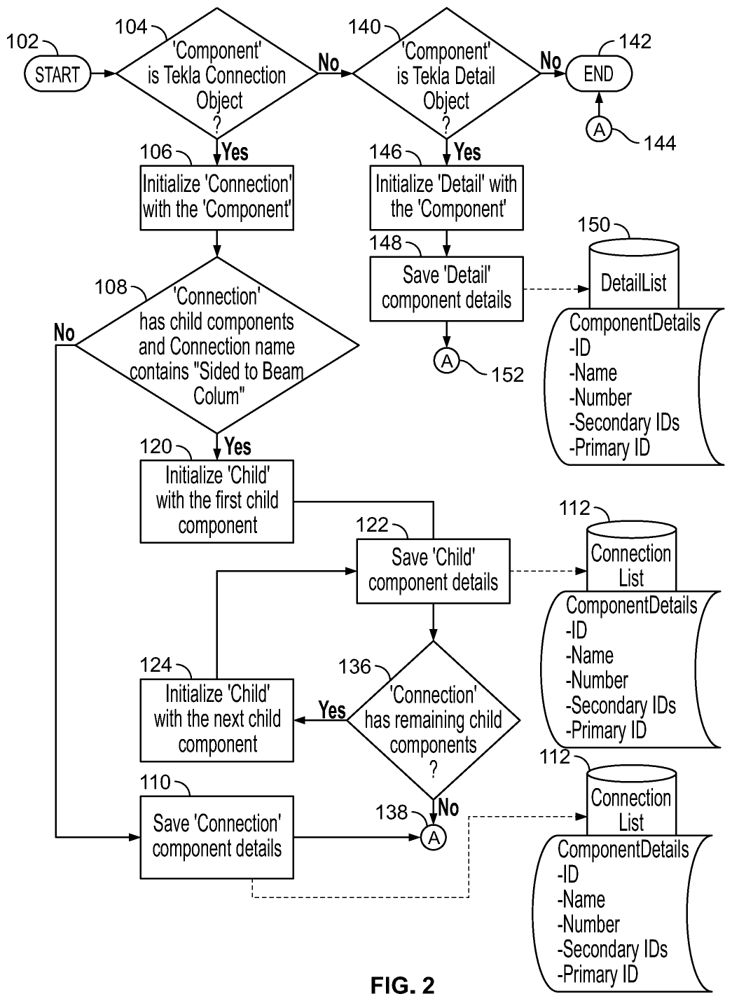

At 30 all of components within the user's initial selection are obtained. At 32 it is determined whether or not there are in fact components in the user's selection. If there are no components within the user's selection, then the process ends at 34. Typically however, there is at least one component in the user's selection, and more commonly there are multiple components within a user's selection. At 36 the variable Component is initialized with the first selected component. At 38 the Get Component Details process is run, as is shown in FIG. 2 and described below. The Get Component Details process gets the details for the component currently represented by the Component variable, including. At 40 it is determined if there are any remaining components that were initially selected by the user. If so, then at 42, the Component variable is initialized for the next selected component, and at 38 the Get Component Details process is run for next component represented by the Component variable. This loop (comprising steps 38, 40, and 42) is continued for each of the selected components until at 40 it is determined that there are no more user-selected selected components.

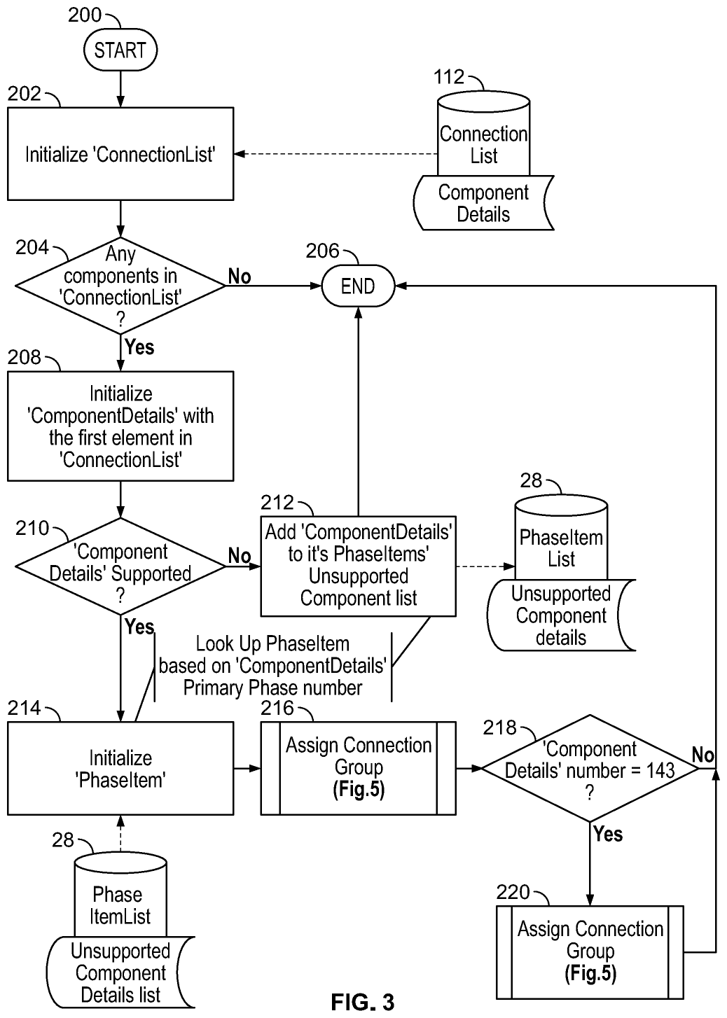

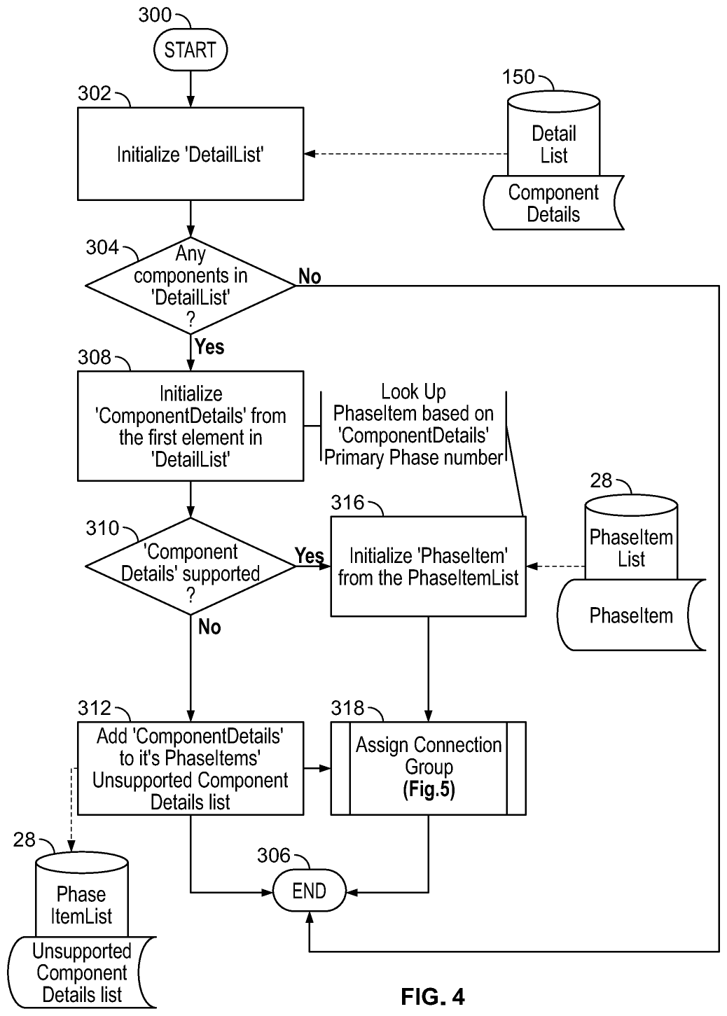

Then at 44 a Group Connection Component process is run, as described below and shown in FIG. 3. The Group Connection Component process. This is followed at 46 with the running of the Group Detail Component process, as described below and shown in FIG. 4. The Group Detail Component process. Finally at 34 the main set connection process ends.

Get Component Details Process

The Get Component Details process discussed above with reference to step 38 is shown in FIG. 2. The Get Component Details Process is run multiple times, once for each selected component that is identified in the Main Set Connection process described above. As shown in FIG. 2, the process begins at 102. At 104 it is determined whether the particular component being processed (and currently represented by the variable Component) is a connection object. In Tekla, components of a connection are typically either a connection object or a detail object. If the subject component represented by the variable Component is a connection object, then at 106 the variable Connection is initialized with the subject component represented by the variable Component.

At 108 the properties of the connection object currently represented by the variable Connection are tested. In the particular example illustrated, it is determined whether the subject component represented by the Connection variable has any child components. It is further determined whether the name field of the ComponentDetails of the variable Connection contains the words “sided to beam column.” If not, then at 110, the component details for the variable Connection are saved in the ConnectionList 112, and the process ends at 138/144. These component details can include the component ID, the component name, the component number, the component primary ID and the component secondary ID's. While Step 108 identifies a component type by a particular name, it should be understood that other component types could be identified using a similar test but for different names. This would be the case, for example if the system and method was going to handle another component that has child components.

If at 108 the subject component represented by the variable Connection does have child components, and if the name field of ComponentDetails for the variable Connection contains the words “sided to beam column,” then at 120, the variable is initialized with ComponentDetails of the first child of the component represented by the variable variable Connection. At 122 the component details of the component represented by the variable Child are saved to the ComponentDetails of the ConnectionList 112. At 136, it is determined whether the component represented by the variable Connection has any remaining child components. If so, then at 124, the variable Child is initialized with the component details of the next child of the component represented by Connection, and at 122 the component details of the child component represented by the variable Child are saved to the ComponentDetails of the ConnectionList 112. At 136 it is again determined whether the component represented by the variable Connection has any remaining child components. If so, the loop (steps 124, 122, and 136) continues until the component represented by Connection has no more child components, i.e., all of the details of the child components of the component represented by the variable Connection have been saved in the ConnectionList. At this point the Get Component Details process ends at 138/144.

If the particular component being processed is not a connection object, then at 140 it is determined whether the particular component being processed is a Detail Object. If the Component is not a Detail Object, then the process ends at 142. If the particular component being processed is a Detail Object, then at 146 the variable Detail is initialized with the details of the component currently represented by the variable Component. At 148 the component details of the variable Detail are saved to the DetailList 150, and at 152/142 the Get Component Details process ends.

After the Get Component Details process has been run for all of the selected components, the ComponentDetails of each of the selected components will be stored in either the ConnectionList 112 (for connection objects) or the DetailList (for detail objects).

Group Connection Component Process

The Group Connection Component process discussed above with reference to step 44 is shown in FIG. 3. This process is run after all of the selected potential connection components have been identified as either Connection Objects or Detail Objects in the Get Component Details method, and their respective details saved in the ConnectionList 112 or the DetailList 150.

The process begins at 200. At 202 ConnectonList 112 created during the Get Component Details process discussed above with respect to FIG. 2, is initialized.

At 204 it is determined whether there are any components in ConnectionList 112. If there are no components in the ConnectionList 112, then at 206 the process ends. If there are components in the Connection List 112, then at 208 the variable ComponentDetails is initialized with the first element in the ConnectionList 112. At 210, it is determined whether the component represented by ComponentDetails is supported, in other words whether it is a component that can be handled by the process. Ideally, all possible components are supported by the process, but to the extent that there are components that are not yet programmed, this step allows them to be identified and segregated. If the component currently represented by ComponentDetails is not supported, then at 212 the element in ComponentDetails is added to the Unsupported Component List of the appropriate PhaseItem List 28. If the processing of the component in ComponentDetails is supported, then at 214, the appropriate PhaseItem is initialized from the PhaseItemList 28, based upon the primary phase number of the component currently represented by ComponentDetails. At 216 the Assign Connection Group Process is run, as described in more detail below. After the Connection Group Process has been run, at 218 it is determined whether the number field for the component currently represented in ComponentDetails equals 143 (which in Tekla corresponds to a particular type of component—a two sided clip angle).

If the number field for the element represented in ComponentDetails equals 143, then at 220 the Assign Connection Group process is run again, as is described in more detail below. If at 218 the number field for the component currently represented in ComponentDetails does not equal 143, then the Group Connection Component process ends at 206.

Group Detail Component Process

The Group Detail Component process discussed above with reference to step 46 is shown in FIG. 4. The process begins at 300. At 302 the DetailList 150 is initialized. At 304 it is determined whether there are any components in the DetailList. If there are no components in the DetailList, the process ends at 306. If there are components in the DetailList, then at 308, the variable ComponentDetails is initialized with the first element in the DetailsList 150.

At 310, it is determined whether the element represented in ComponentDetails is supported, in other words whether it is a component that can be handled by the process. Ideally, all possible components are supported by the process, but to the extent that there are components that are not yet programmed, this step allows them to be identified and segregated. If the component represented by the variable ComponentDetails is not supported, then at 312 the element represented by ComponentDetails is added to the Unsupported Component Details List of the appropriate PhaseItem List 28. If the component represented by the variable ComponentDetails is supported, then at 316, the appropriate PhaseItem is initialized from the PhaseItemList 28 based upon the primary phase number of the component currently represented by ComponentDetails. At 318 the Assign Connection Group process is run, as described in more detail below, and the Group Detail Component process ends at 306.

Assign Connection Group Process

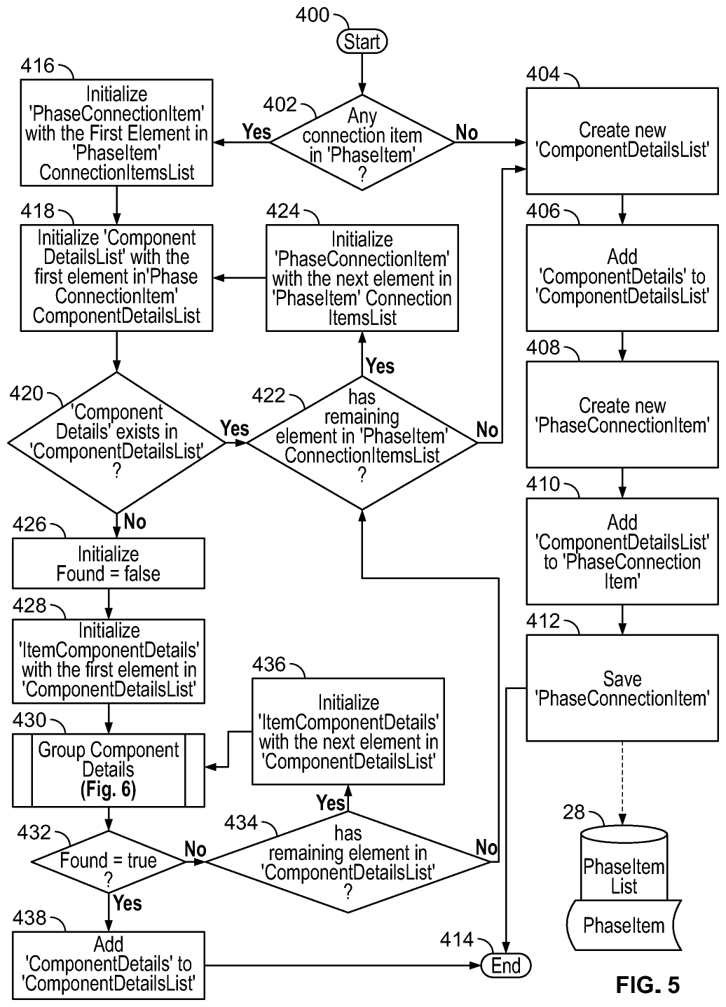

The Assign Connection Group Process referenced in connection with steps 216 and 318, is shown in FIG. 5. This process assigns the Connection Objects and the Detail Objects identified in the Group Connection Component Process and the Group Detail Component Process to a connection.

The Assign Connection Group process begins at 400. At 402 it is determined whether there is any connection item in PhaseItem, in other words whether. If there is a connection item in PhaseItem, then at 416 the variable PhaseConnectionItem is initialized with the first element in the ConnectionItemsList in PhaseItem. At 418 the variable ComponentDetailList is initialized with the first element of the ComponentDetailsList in PhaseConnectionItem. At 420 it is determined whether ComponentDetails exist in the ComponentDetailsList, in other words whether. If ComponentDetails exist in ComponentDetailsList at 420, then at 422 it is determined whether there is a remaining element in the ConnectionItemsList of PhaseItem. If there is a remaining element in the ConnectionItemsList, then at 424 PhaseConnectionItem is initialized with the next element of in the ConnectionItemsLists of PhaseItem. At 418 the ComponentDetailList is initialized in the ComponentDetailsList in PhaseConnectionItem. This loop continues for as long as ComponentDetails exist in ComponentDetailsList. If there is not a remaining element in the ConnectionItemsList of PhaseItem at 422, then at 404 a new ComponentDetailsList is created at 404, and the process continues as described below.

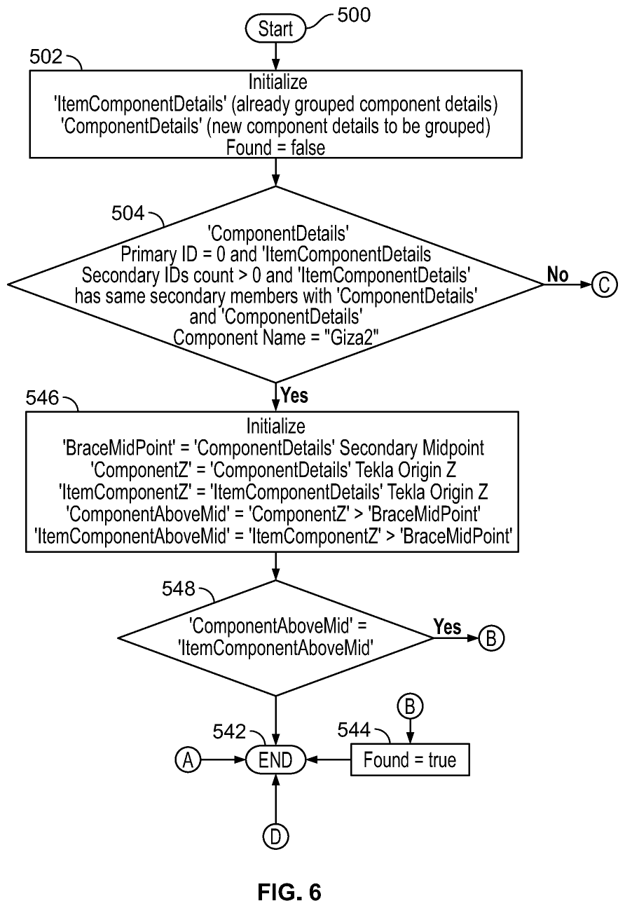

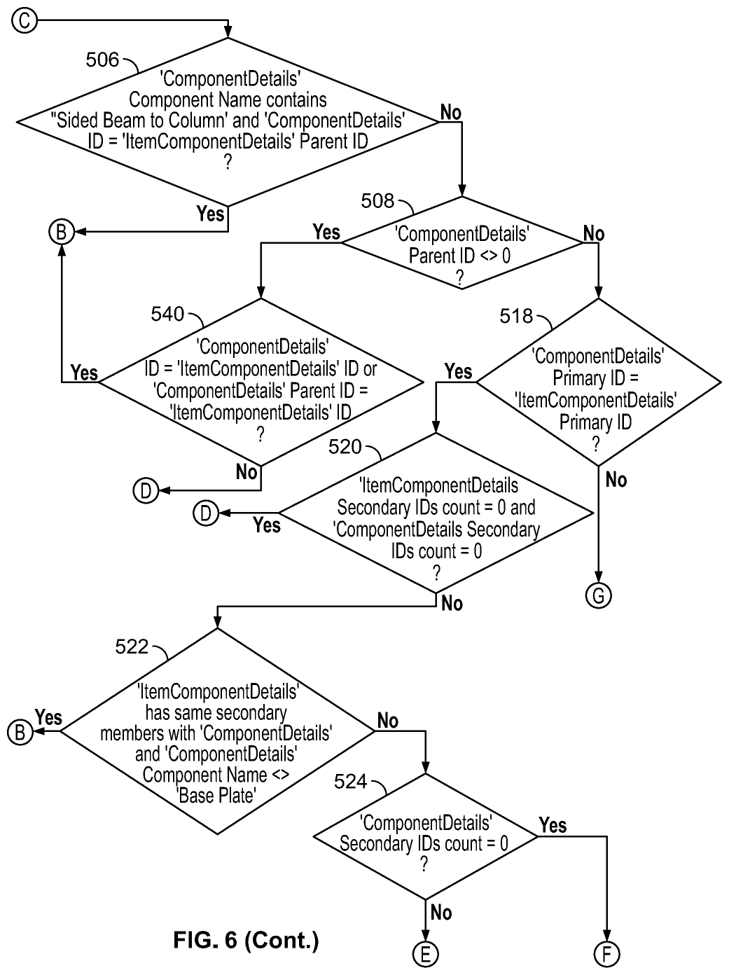

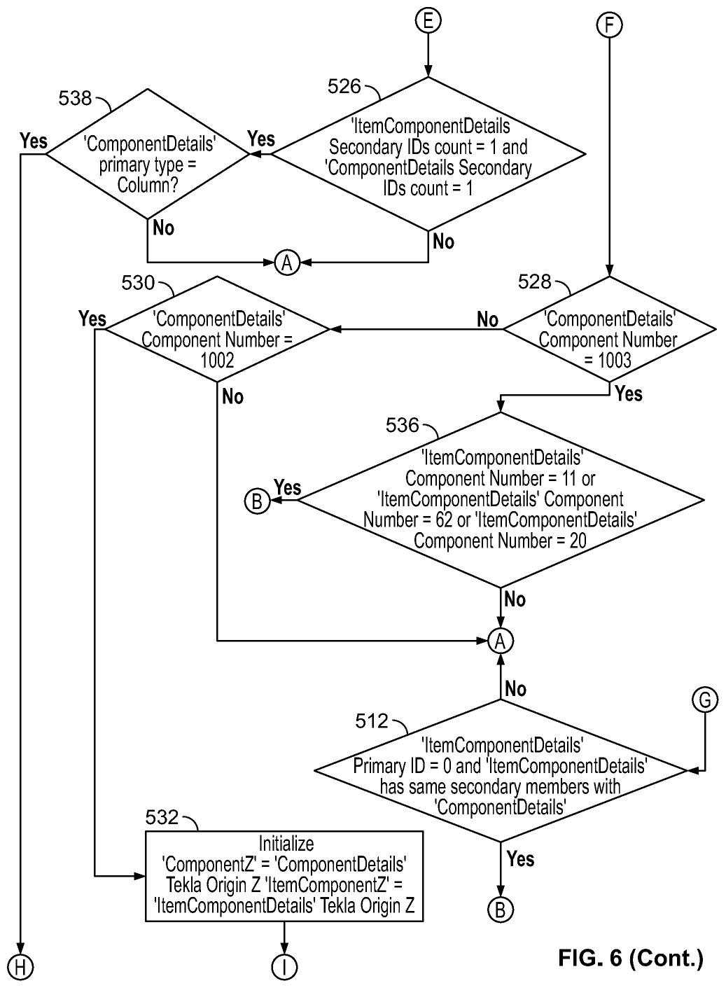

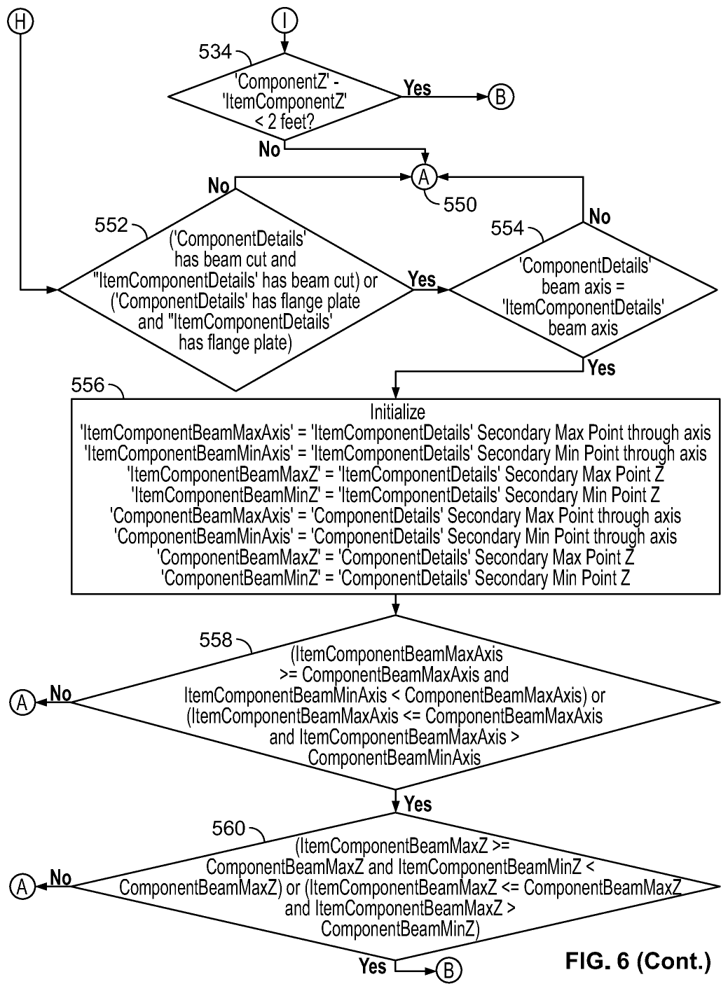

If at 420 ComponentDetails are not found to exist in ComponentDetailsList, then at 426 the variable Found is initialized to “false” and at 428 the variable ItemComponentDetails is initialized with the first element in ComponentDetailsList. At 430, the Group Component Details process, described below in connection with FIG. 6, is run. At 432 it is determined whether Found=“true.” If Found does equal “true”, then the ComponentDetails are added to the ComponentDetailsList, and the process ends at 414. If at 432 Found does not equal “true,” then at 434 it is determined whether there is a remaining element in ComponentDetailsList. If there is a remaining element in ComponentDetailList, then at 436 ItemComponentDetails is initialized with the next element in ComponentDetailsList, and at 430 the Group Component Details process is run. This loop (steps 434, 436 and 430) continues until at 432 the variable Found equals “true” or at 434 no remaining element is found in ComponentDetailsList.

When at 434 there is no remaining element in ComponentDetailsList, then at 422 it is determined whether there are remaining elements in the ConnectionItemsList of PhaseItem. If there are remaining elements in the ConnectionItemsList then at 424 PhaseConnectionItem is initialized with the next element in the ConnectionItemsList in PhaseItem. This loop continues until at 422 it is determined that there are no remaining elements in the ConnectionItemsList of PhaseItem. If there are no remaining elements in ConnectionItemsList in Phase item then at 404 a new ComponentDetailslist is created, and the process continues at 406 as described below.

If, at 402, it is determined that there are no connection items in PhaseItem, then at 404 a new ComponentDetailsList is created. Then at 406 the ComponentDetails are added to the newly created ComponentDetailsList. At 408 a new PhaseConnectionItem is created. Then at 410 the ComponentDetailslist is added to the PhaseConnectionItem. At 412, the Phase Connection item is saved to the PhaseItem List 28. Finally at 414, the Assign Connection Group process ends.

Group Component Details Process

The Group Component Details process referenced in step 430 is shown in FIG. 6. The Group Component Details process begins at 500. At 502 ItemComponentDetails (the already grouped component details), and ComponentDetails (the new component details to be grouped) are initialized, and Found is initialized to “false.” At 504 it is determined whether ComponentDetails Primary ID=0 (signifying) and ItemComponentDetails Secondary IDs count>0 (signifying) and ItemComponentDetails has same secondary members with ‘ComponentDetails (signifying) and the Component Name of ComponentDetails=“Giza2” (signifying). If all of these conditions are true, then at 546 BraceMidPoint is initialized to ComponentDetails Secondary Midpoint, ComponentZ is initialized to ComponentDetails Tekla Origin Z, ItemComponentZ is initialized to ItemComponentDetails Tekla Origin Z, ComponentAboveMid is initialized to ComponentZ>BraceMidPoint, and ItemComponentAboveMid is initialized to ItemComponentZ>BraceMidPoint. This.

At 548, it is determined whether ComponentAboveMid equals ItemComponentAboveMid (signifying). If not, then the process ends at 542. If, at 548, it is determined that ComponentAboveMid equals ItemComponentAboveMid, (signifying) then at 544, the Found is set to “true” and at 542 the process ends.

If at step 504, the conditions are not met, then at 406, it is determined whether the Component Name of the ComponentDetails contains the words “Sided Beam to Column” and whether the ComponentDetails ID equals the Parent ID ItemComponentDetails. This signifies. If so, then at 544, Found is set to “true” and the process ends. If at 506 these conditions are not true, then at 508, it is determined whether Parent ID in ComponentDetails is not equal to 0 (signifying). If the Parent ID in ComponentDetails is not equal to 0, then at 540 it is determined whether ComponentDetails ID=ItemComponentDetails ID (signifying) or the Parent ID of ComponentDetails=ItemComponentDetails ID (signifying). If either of these conditions is true, then at 544 Found is set to “true” and the process ends at 542. If neither of these conditions is true, then the process ends at 542.

If, at 508 it is determined that the Parent ID of ComponentDetails is equal to 0, then at 518 it is determined whether the Primary ID of ComponentDetails=the Primary ID of ItemComponentDetails (signifying). If so, then at 520 it is further determined whether both Secondary IDs count of ItemComponentDetails=0 and Secondary IDs count of ComponentDetails=0 (signifying). If so, the process ends at 542. If both Secondary IDs count of ItemComponentDetails=0 and Secondary IDs count of ComponentDetails=0 are not true, then at 522 it is determined whether ItemComponentDetails has same secondary members as ComponentDetails, and Component Name of ComponentDetails does not equal “Base Plate” (signifying). If both of the conditions of 522 are true, then at 544 Found is set to “true” and the process ends at 542. If either of the conditions of 522 is not true, then at 524 it is determined whether the Secondary IDs count of ComponentDetails=0, (signifying). If the Secondary IDs count of ComponentDetails′ 0 at 524, then at 528 it is determined whether Component Number of ComponentDetails=1003 (signifying). If the Component Number of ComponentDetails does not equal 1003 at 528, then at 530 it is determined whether Component Number of ComponentDetails=1002 (signifying). If at 530 the Component Number of ComponentDetails does not equal 1002, then the process ends at 542. If at 530 the Component Number of ComponentDetails does equal 1002, then at 532 ComponentZ=is initialized to ComponentDetails Tekla Origin Z, and ItemComponentZ is initialized to ItemComponentDetails′Tekla Origin Z (signifying). After this initialization, at 534 it is determined whether ComponentZ−ItemComponentZ<2 feet (signifying). If at 534 ComponentZ−ItemComponentZ is not less than 2 feet, at 536 then the process ends at 542. If at 534 ComponentZ−ItemComponentZ is less than 2 feet, then at 544 Found is set to “true” and the process ends at 542.

If the Secondary IDs count of ComponentDetails does not equal 0 at 524, then at 526 it is determined whether Secondary IDs count of ItemComponentDetails=1 and the Secondary IDs count of ComponentDetails=1 (signifying). If at 526 these conditions are not true, then the process ends at 542. If at 526, both of these conditions are true, then at 538 it is determined whether primary type of ComponentDetails=“Column” (signifying). If the primary type of ComponentDetails is not “Column at 538 then the process ends at 542. If primary type of ComponentDetails is “Column” at 538 then at 552 it is determined whether either ComponentDetails has beam cut and ItemComponentDetails has beam cut, or ComponentDetails has flange plate and ItemComponentDetails has flange plate (signifying). If at 552 neither of these conditions are true (signifying), the process ends at 542. If at 552 either of these conditions is true (signifying), then at 554 it is determined whether beam axis of ComponentDetails=the beam axis of ItemComponentDetails (signifying). If this is not true, then the process ends at 542. If at 554 the beam axis of ComponentDetails equals the beam axis of ItemComponentDetails, (signifying) then at 556, ItemComponentBeamMaxAxis is initialized to the Secondary Max Point through axis of ItemComponentDetails; ItemComponentBeamMinAxis' is initialized to the Secondary Min Point through axis of ItemComponentDetails; ItemComponentBeamMaxZ is initialized to the Secondary Max Point Z of ItemComponentDetails; ItemComponentBeamMinZ is initialized to the Secondary Min Point Z of ItemComponentDetails; ComponentBeamMaxAxis is initialized to the Secondary Max Point through axis of ItemComponentDetails; ComponentBeamMinAxis is initialized to the Secondary Min Point through axis of ComponentDetails; ComponentBeamMaxZ is initialized to Secondary Max Point Z ComponentDetails; and ComponentBeamMinZ is initialized to Secondary Min Point Z of ComponentDetails. Then, at 558 it is determined if either (1) ItemComponentBeamMaxAxis is greater than or equal to ComponentBeamMaxAxis and ItemComponentBeamMinAxis is less than ComponentBeamMaxAxis) (signifying), or (2) ItemComponentBeamMaxAxis is less than or equal to ComponentBeamMaxAxis and ItemComponentBeamMaxAxis is greater than ComponentBeamMinAxis, is true (signifying). If neither condition is true at 558, the process ends at 542. If either of the conditions at 558 is true, then at 560 it is determined if either (1) (ItemComponentBeamMaxZ is greater than or equal to ComponentBeamMaxZ and ItemComponentBeamMinZ is less than ComponentBeamMaxZ (signifying) or (2) (ItemComponentBeamMaxZ is less than or equal to ComponentBeamMaxZ and ItemComponentBeamMaxZ is greater than ComponentBeamMinZ (signifying). If neither condition at 560 is true, then the process ends at 542. If either condition is true at 560, then Found is set to “true” at 544, and the process ends at 542.

If at 518 it is determined that Primary ID of ComponentDetails does not equal the Primary ID of ItemComponentDetails (signifying), then at 512, it is determined whether the Primary ID of ItemComponentDetails'=0 and ItemComponentDetails has same secondary members as ComponentDetails (signifying). If these conditions at 512 are true, then Found is set to “true” at 544, and the process ends at 542. If these conditions are 512 are not true, than the process ends at 542.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer implemented method of automatically identifying the components that belong to the same connection between members in a model existing in a building information modelling program, the method comprising the steps of:
accepting a user selection of a portion of the model for processing;
processing the selected portion of the model to identify connection components; and
sorting the identified connection components into connection groups using a set of rules.

2. The method according to claim 1 wherein the set of rules include at last one rule based upon location of the component within the model.

3. The method according to claim 1 wherein the set of rules include at least one rule based upon the name of the component.

4. The method according to claim 1 wherein the set of rules include at least one rule based upon the number of the component.

5. The method according to claim 1 wherein the set of rules include at least one rule based upon the position of the component relative to a member to which it connects.

6. The method according to claim 1 wherein the set of rules include at least one rule based upon whether the component connects to another component.

7. The method according to claim 1, wherein the components comprise connection objects and detail objects, and further comprising the step of separating the connection objects from the detail objects prior to sorting the identified connection components into connection groups.

8. The method according to claim 1, wherein the model is divided into at least two phases, and wherein the set of rules include at least one rule based upon the phase to which the component belongs.
